(19) United States
(12) Patent Application Publication
(10) Pub. No.: US 2016/0296064 A1
(43) Pub. Date: Oct. 13, 2016

(54) All plastic liquid boiling tank for hot liquid dispensing devices

(71) Applicant: SOLVAY SPECIALTY POLYMERS USA, LLC, Alpharetta, GA (US)

(72) Inventors: Brian BALENO, Alpharetta (GA); Glenn CUPTA, Roswell, GA (US)

(73) Assignee: SOLVAY SPECIALTY POLYMERS USA, LLC, Alpharetta, GA (US)

(21) Appl. No.: 15/034,035

(22) PCT Filed: Oct. 27, 2014
(86) PCT No.: PCT/EP2014/072938

§ 371 Date: May 3, 2016

Related U.S. Application Data
(60) Provisional application No. 61/900,676, filed on Nov. 6, 2013.

(51) Int. Cl. A47J 31/54; A47J 31/46

(52) U.S. Cl. CPC A47J 31/54; A47J 31/46

(57) ABSTRACT

The present invention relates to beverage brewing devices for dispensing a brewed beverage comprising a liquid boiling tank being free from any metallic hollow part comprising at least one hollow part made from a polymer composition (C) comprising at least one polymer selected from the group consisting of amorphous polymers having a glass transition temperature of at least 150° C. and semi-crystalline polymers having a melting point temperature of at least 250° C.

This application claims priority to U.S. provisional application No. 61/900,676 filed. Nov. 6, 2013, the whole content of this application being incorporated herein by reference for all purposes.

### TECHNICAL FIELD

The present application relates to appliances for heating liquids and brewing beverages, and more specifically to a device for brewing and dispensing a brewed beverage such as coffee, chocolate or tea. More specifically, the present invention relates to hot liquid dispensing devices for dispensing hot liquid or brewed beverages comprising a liquid boiling tank, wherein the liquid boiling tank comprises a heating device and, in direct contact with it, at least one hollow enclosed vessel made from a polymer selected from the group consisting of amorphous polymers having a glass transition temperature of at least 150° C. and semi-crystalline polymers having a melting point temperature of at least 250° C.

### BACKGROUND ART

Beverage brewing devices such as those for making coffee, tea and other brewed beverages, are well known in the art. In the last few years, there has been an increasing demand on the market for beverage brewing devices such as espresso coffee machines that produce high quality coffee for domestic use. In addition, domestic hot water dispensing machines of hot drinking water used for the preparation of tea, coffee or soup are also well known and globally used.

Commercially available hot water dispensing machines or beverage brewing devices comprise a water boiling tank which brings the water to be used in preparing the beverages to the appropriate temperature, i.e., approximately 90° C. Today, the water boiling tanks of beverage brewing devices or hot water dispensing machines always comprise at least one hollow vessel made of metal, mainly stainless steel. U.S. Pat. No. 6,549,854 discloses a liquid heating module for use in a hot beverage machine comprising a hollow tube made of metallic material, preferably stainless steel.

The use of stainless steel in those water boiling tanks comes unfortunately with a few drawbacks. First of all, stainless steel is not fully corrosion-proof on the long run. U.S. Pat. No. 8,383,034 deals with this issue by suggesting the use of a ferritic stainless steel of a specific composition to avoid this problem. In addition, a major drawback in stainless steel water boiling tanks is the high amount of calcium build-up and scaling. Another drawback of those tanks is associated to their overall weight. Still another drawback related to the use of stainless steel for the manufacture of those boiling tanks is related to its very high thermal conductivity which dissipates the heat off of the boiling tanks and is therefore not energy efficient. Finally, stainless steel tanks with somewhat sophisticated designs are not easy to manufacture.

An object of the present invention is thus to provide a hot liquid dispensing machine or beverage brewing device comprising a liquid boiling tank which is highly durable, easy and inexpensive to maintain, has a competitive production cost, do not corrode over time, do not impart any taste to the liquid, is resistant to calcium build-up and scaling, is easy to manufacture, even with intricate designs and shapes, is not thermally conductive (in order to maintain the liquid at high temperature as long as possible and be therefore more energy efficient) and may be flame proof according to international standards for domestic electrical appliances such as the UL94.

In addition, the liquid boiling tank should ideally also be chemical resistant (in particular to acids and chlorinated liquid), have a long term hydrolytic stability and also be compliant to the health and safety regulations such as the ones stated by the FDA and the European Commission.

### SUMMARY OF THE INVENTION

Therefore, a first aspect of the present invention relates to a hot liquid dispensing device for dispensing hot water or brewed beverages comprising a liquid boiling tank, wherein the liquid boiling tank:
comprises at least one hollow vessel made from a polymer composition (C) comprising at least one polymer (P) selected from the group consisting of amorphous polymers having a glass transition temperature of at least 150° C. and semi-crystalline polymers having a melting point temperature of at least 250° C., and
a heating device, wherein the heating device is in direct contact with said hollow vessel.

Another aspect of the present invention relates to method for the preparation of tea, coffee, soup or other hot beverages where hot liquid is dispensed from the hot liquid dispensing device of the present invention.

### DETAILED DESCRIPTION OF THE INVENTION

According to the present invention, the term “hot liquid dispensing device” is intended to denote any electrically operated form of hot drinking liquid producing and dispensing device. The hot liquid dispensing device of the present invention is particularly well suited for dispensing hot liquid (i.e at a temperature of about 80-100° C.) which can be used for the preparation of hot beverages such as coffee, tea, chocolate, soup or other hot beverages.

According to the present invention, the term “hot liquid” is intended to denote hot water or hot beverages including coffee, tea, milk, chocolate and soup. The “hot liquid” has generally a temperature of about 80-100° C., preferably about 90° C.

The hot liquid dispensing device of the present invention may be a hot water dispensing device or a beverage brewing device.

According to the present invention, the term “beverage brewing device” is intended to denote any electrically operated form of beverage producing and dispensing device. The beverage brewing device of the present invention is particularly well suited for the preparation of hot beverages such as coffee, tea, chocolate or soup.

Also, according to the present invention, the term “liquid boiling tank” is intended to denote any hollow body suitable for the storage and heating of liquids in hot liquid dispensing devices. The liquid boiling tank of the hot liquid dispensing device according to the present invention comprises at least one hollow vessel made from a polymer composition (C). The liquid contained in the hollow vessel is heated by the action of a heating device in direct contact with said hollow vessel.

When in use and when the liquid boiling tank is filled with liquid, the heating device brings the liquid in the hollow vessel to a temperature of about 80-100° C., generally of about 90° C. The heating device may be a thermoblock heating or an on demand heater (ODH) device. It is preferably an ODH device.

According to the invention, the term “thermoblock heating device” is intended to mean a heating device maintained at a given standby temperature of about 80-120° C. whose function is to heat the liquid in the hollow vessel. To keep the heated liquid as close as possible to the target temperature of the hot liquid, the thermoblock heating device is normally equipped with a feedback control, which, depending on the temperature of the liquid surrounding the thermoblock, turns the heating device on and off to control the temperature of the thermoblock and compensate for any fall or rise in temperature.

According to the invention, the term “on demand heater (ODH) device” is intended to denote another type of a heating device, different from the thermoblock heating device, where the liquid is not maintained at a given standby temperature but is only heated when the hot liquid dispensing device is in use. The ODH device brings the temperature of the liquid to a temperature of about 80-100° C. An example of such an ODH device is disclosed in EP 1253844.

The improvement of this invention lies in the material(s) used for the manufacture of the liquid boiling tank. As explained above, the use of stainless steel comes with many drawbacks which are avoided when using the present polymer composition (C).

The Applicant has found that the polymer composition (C) provides all the key requirements for the manufacture of liquid boiling tanks including a very high temperature resistance, superior mechanical properties retention in hot and humid environments, and outstanding chemical resistance which, together, provide reliable operation in this specific end-use. In particular, the Applicant found that all the technical and market requirements for liquid boiling tanks were met when they were made from the polymer composition (C) comprising at least one polymer (P) selected from the group consisting of amorphous polymers having a Tg of at least 140° C. and semi-crystalline polymers having a Tm of at least 250° C. (hereinafter “polymer (P)”).

The Applicant has found that materials not complying with these prerequisites, even if compounded with high loads of reinforcing fillers, were unable to provide the above mentioned requirements.

Further, the polymer of (P) has preferably, in addition to the above mentioned Tg or Tm requirement, a heat deflection temperature (HDT, herein below) of above 80° C., preferably 90° C. and even more preferably 100° C. under a load of 1.82 MPa when measured according to ASTM D648. Actually, certain polymers might not have detectable Tg; in such a case, HDT can be suitably used to have an indication of the upper temperature at which structural resistance of the material begins to decrease.

Tg and Tm are determined by DSC, according to ASTM D3418 using a heating and cooling rate of 20° C./min in nitrogen atmosphere.

HDT values of polymers are determined according to ASTM D648, Method A, using a span of 4 inches. The polymer is injection moulded into plaques that are 5 inches long, ½ inch wide, and ⅛ inch thick. The plaques are immersed in a suitable liquid heat-transfer medium, such as oil, during the HDT test. Dow Corning 710 silicone oil, for example, can be used.

The at least one polymer (P) is present in the polymer composition (C) in an amount of generally at least 40 wt. %, preferably of at least 45 wt. %, more preferably of at least 50 wt. %, more preferably of at least 60 wt. %, more preferably of at least 65 wt. %, based on the total weight of the polymer composition (C).

It is further understood that the at least one polymer (P) is present in the polymer composition (C) in an amount of generally at most 99.9 wt. %, preferably of at most 95 wt. %, more preferably of at most 90 wt. %, more preferably of at most 85 wt. %, more preferably of at most 80 wt. %, more preferably of at most 75 wt. %, more preferably of at most 70 wt. %, based on the total weight of the polymer composition (C).

The polymer (P) is preferably free from carbonate and/or ester moieties.

In a first embodiment, the polymer composition (C) comprises at least one amorphous polymer having a Tg of at least 150° C. Preferably, the Tg of the at least one amorphous polymer is of at least 145° C., more preferably of at least 150° C., still more preferably of at least 160° C. In certain embodiment, it is even preferably of at least 180° C. more preferably of at least 200° C., still more preferably of at least 210° C.

The amorphous polymer having a Tg of at least 150° C. is preferably selected from the group consisting of poly(aryl ether sulfones), polyamides and polyetherimides, still more preferably selected from the group consisting of poly(aryl ether sulfones) and polyetherimides.

### The Poly(Aryl Ether Sulfones)

For the purpose of the present invention, the expressions “poly(aryl ether sulfone)” is intended to denote any polymer of which more than 50 wt. % of the recurring units are recurring units (R_{PS}) of one or more formulae containing at least one arylene group, at least one ether group (—O—) and at least one sulfone group [—S(═O)₂—].

In the poly(aryl ether sulfone) as above detailed preferably more than 60%, more preferably more than 80%, still more preferably more than 90% moles of the recurring units are recurring units (R_{PS}), as above detailed. Still, it is generally preferred that substantially all recurring units of poly(aryl ether sulfone) are recurring units (R_{PS}), as above detailed

The arylene group of the poly(aryl ether sulfone) may be aromatic radicals comprising from 6 to 36 carbon atoms, which are optionally substituted by at least one substituent selected from the group consisting of halogen, alkyl, alkenyl, alkynyl, aryl, arylalkyl, nitro, cyano, alkoxy, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium.

The recurring units (R_{PS}) are advantageously recurring units of formula (A) as shown below:

—Ar¹-(T′—Ar²)ₙ—O—Ar³—SO₂—[Ar⁴-(T-Ar²)ₙ—SO₂]ₘ—Ar⁵—O— (A)

wherein:
Ar¹, Ar², Ar³, Ar⁴, and Ar⁵, equal to or different from each other and at each occurrence, are independently an aromatic mono- or polynuclear group;
T and T′, equal to or different from each other and at each occurrence, is independently a bond or a divalent group optionally comprising one or more than one heteroatom;
n and m, equal to or different from each other, are independently zero or an integer of 1 to 5;

Preferably, Ar¹, Ar², Ar³, Ar⁴ and Ar⁵ are equal or different from each other and are aromatic moieties preferably selected from the group consisting of those complying with following formulae:

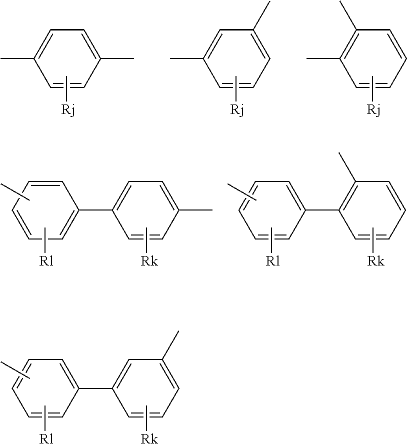

wherein each R is independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k and l equal or different from each other, are independently 0, 1, 2, 3 or 4.

Ar² may further be selected from the group consisting of fused benzenic rings such as naphthylenes (and in particular 2,6-naphthylene), anthrylenes (and in particular 2,6-anthrylene) and phenanthrylenes (and in particular 2,7-phenanthrylene), naphthacenylenes and pyrenylenes groups; an aromatic carbocyclic system comprising from 5 to 24 atoms, at least one of which is a heteroatom, such as pyridines, benzimidazoles, quinolines, etc. The hetero atom is often chosen from B, N, O, Si, P and S. It is more often chosen from N, O and S.

Preferably, T and T′, equal to or different from each other, are selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —R^{a}C═CR^{b}—; where each R^{a} and R^{b}; independently of one another, is a hydrogen or a C₁-C₁₂-alkyl, C₁-C₁₂-alkoxy, or C₆-C₁₈-aryl group; —(CH₂)ₙ— and —(CF₂)ₙ— with n=integer from 1 to 6, or an aliphatic divalent group, linear or branched, of up to 6 carbon atoms; and mixtures thereof.

Recurring units (R_{PS}) can be notably selected from the group consisting of those of formulae (B) to (E) herein below:

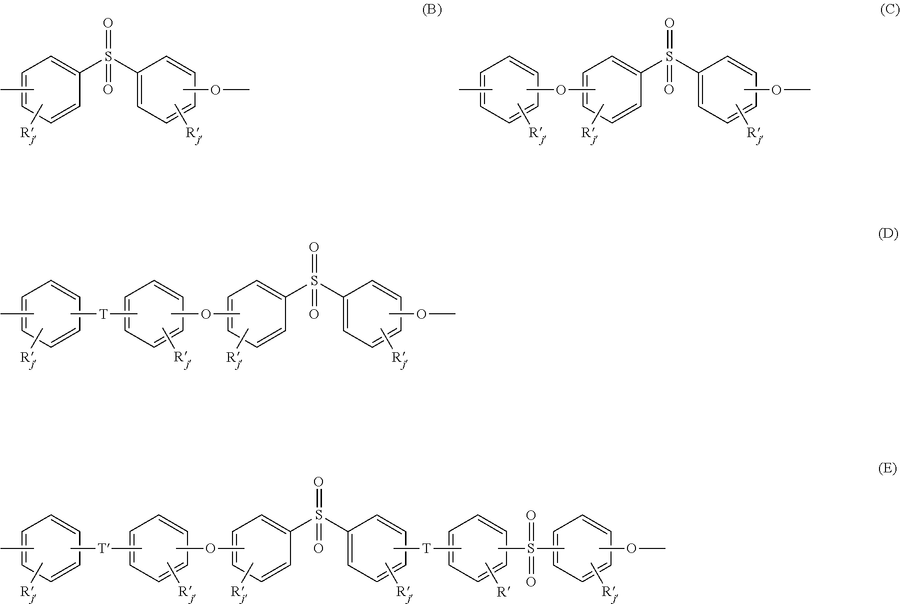

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4;
T and T′, equal to or different from each other, is selected from the group consisting of a bond, —CH₂—; —O—; —SO₂—; —S—; —C(O)—; —C(CH₃)₂—; —C(CF₃)₂—; —C(═CCl₂)—; —C(CH₃)(CH₂CH₂COOH)—; —N═N—; —R^{a}C═CR^{b}—; where each R^{a} and R^{b}; independently of one another, is a hydrogen or a C₁-C₁₂-alkyl, C₁-C₁₂-alkoxy, or C₆-C₁₈-aryl group; —(CH₂)ₙ— and —(CF₂)ₙ— with n=integer from 1 to 6, or an aliphatic divalent group, linear or branched, of up to 6 carbon atoms; and mixtures thereof.

As will be detailed later on, the poly(aryl ether sulfone) of the polymer composition (C) may be a poly(biphenyl ether sulfone), such as a polyphenylsulfone which is especially preferred. Alternatively, the poly(aryl ether sulfone) may be a polyethersulfone, a polyetherethersulfone or a bisphenol A polysulfone.

For the purpose of the present invention, a poly(biphenyl ether sulfone) is intended to denote any polymer of which more than 50 wt. % of the recurring units are recurring units (R_{PSa}) of one or more formulae containing at least one ether group (—O—), at least one sulfone group [—S(═O)₂—] and at least two groups (G*) chosen from phenylene, naphthylenes (such as 2,6-naphthylene), anthrylenes (such as 2,6-anthrylene) and phenanthrylenes (such as 2,7-phenanthrylene), naphthacenylenes and pyrenylenes, each of said groups (G*) being joined to at least one group (G*) different from itself, directly by at least one single bond and, optionally in addition, by at most one methylene group. Accordingly, groups (G*) may thus be joined together to form notably biphenylene groups such as p-biphenylene, 1,2′-binaphthylene groups, triphenylene groups such as p-triphenylene and fluorenylene groups (i.e. divalent groups derived from fluorene).

The recurring units (R_{PSa}) are advantageously recurring units of formula (A), as defined above, with the proviso that at least one Ar¹ through Ar⁵ is an aromatic moiety preferably selected from the group consisting of those complying with following formulae:

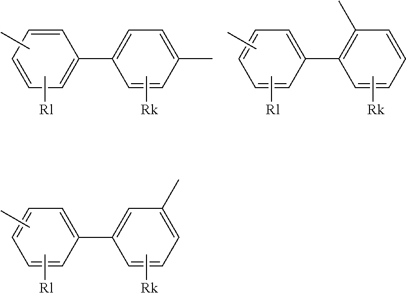

wherein R is independently selected from the group consisting of:
hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and k and 1 equal or different from each other, are independently 0, 1, 2, 3 or 4.

The definitions and preferences described above for T, T′, Ar′, Ar¹, Ar², Ar³, Ar⁴, Ar⁵, n and m equally apply here.

More preferably, recurring units (R_{PSa}) are chosen from

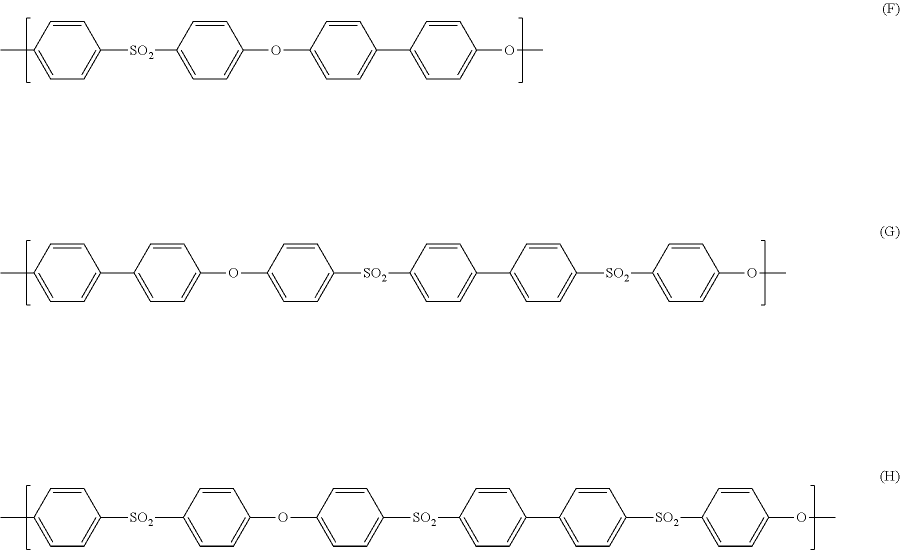

and mixtures thereof.

For the purpose of the present invention, a polyphenylsulfone (PPSU) is intended to denote any polymer of which more than 50 wt. % of the recurring units are recurring units (R_{PSa}) of formula (F).

Preferably more than 75 wt. %, preferably more than 85 wt. %, preferably more than 95 wt. %, preferably more than 99 wt. % of the recurring units of the poly(biphenyl ether sulfone) of the polymer composition (C) are recurring units (R_{PSa}).

RADEL® PPSU and DURADEX® D-3000 PPSU from Solvay Specialty Polymers USA, L.L.C. are examples of polyphenylsulfone homopolymers.

Poly(biphenyl ether sulfone)s can be prepared by known methods.

Methods well known in the art are those described in U.S. Pat. Nos. 3,634,355; 4,008,203; 4,108,837 and 4,175,175, the whole contents of which are herein incorporated by reference.

For the purpose of the present invention, a polyethersulfone (PESU) is intended to denote any polymer of which more than 50 wt. % of the recurring units are recurring units (R_{PSb}) of formula (I):

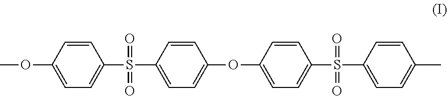

Preferably more than 75 wt. %, preferably more than 85 wt. %, preferably more than 95 wt. %, preferably more than 99 wt. % of the recurring units of the polyethersulfone are recurring units (R_{PSb}) of formula (I). Most preferably all the recurring units of the polyethersulfone of the polymer composition (C) are recurring units (R_{PSb}) of formula (I).

Polyethersulfone can be prepared by known methods and is notably available as VERADEL® PESU from Solvay Specialty Polymers USA, L.L.C.

For the purpose of the present invention, a polyetherethersulfone is intended to denote any polymer of which more than 50 wt. % of the recurring units are recurring units (R_{PSc}) of formula (J):

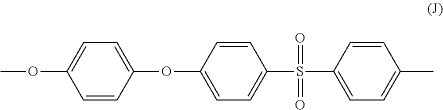

Preferably more than 75 wt. %, preferably more than 85 wt. %, preferably more than 95 wt. %, preferably more than 99 wt. % of the recurring units (R_{PSc}) of the polyetherethersulfone are recurring units of formula (J). Most preferably all the recurring units of the polyetherethersulfone are recurring units (R_{PSc}) of formula (J).

Polyetherethersulfones can be prepared by known methods.

For the purpose of the present invention, a bisphenol A polysulfone (PSU) is intended to denote any polymer of which more than 50 wt. % of the recurring units are recurring units (R_{PSd}) of formula (K):

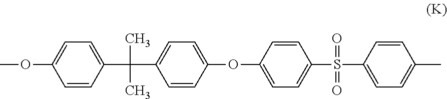

Preferably more than 75 wt. %, preferably more than 85 wt. %, preferably more than 95 wt. %, preferably more than 99 wt. % of the recurring units of the bisphenol A polysulfone are recurring units (R_{PSd}) of formula (K). Most preferably all the recurring units of the bisphenol A polysulfone are recurring units (R_{PSd}) of formula (K).

The bisphenol A polysulfones are notably available as UDEL® PSU from Solvay Specialty Polymers USA, L.L.C.

According to a preferred embodiment of the invention, the poly(aryl ether sulfone) of the polymer composition (C) is selected among poly(biphenyl ether sulfone)s as detailed above, more preferably from the group consisting of PSU, PESU and PPSU and is most preferably a PPSU.

### The Polyetherimides

For the purpose of the present invention, the expression “polyetherimides” is intended to denote any polymer of which more than 50 wt. % of the recurring units (R_{PEI}) comprise at least one aromatic ring, at least one imide group, as such and/or in its amic acid form, and at least one ether group [recurring units (R_{PEIa})].

Recurring units (R_{PEIa}) may optionally further comprise at least one amide group which is not included in the amic acid form of an imide group.

The recurring units (R_{PEIa}) are advantageously selected from the group consisting of following formulae (L), (M), (N), (O) and (P), and mixtures thereof:

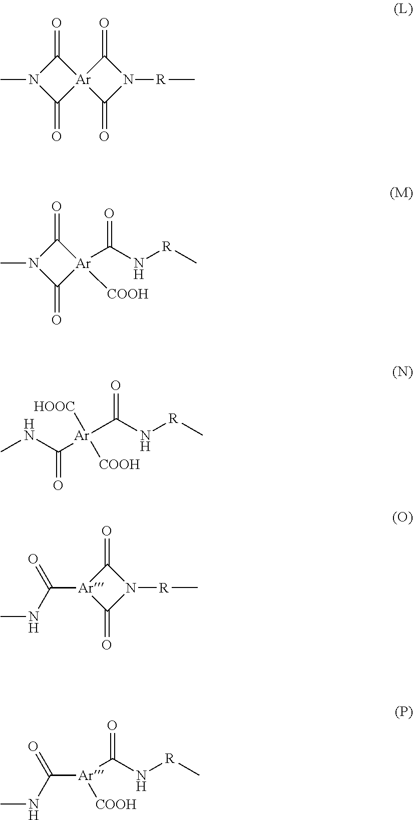

wherein:
Ar is a tetravalent aromatic moiety and is selected from the group consisting of a substituted or unsubstituted, saturated, unsaturated or aromatic monocyclic and polycyclic group having 5 to 50 carbon atoms;
Ar′″ is a trivalent aromatic moiety and is selected from the group consisting of a substituted or unsubstituted, saturated, unsaturated or aromatic monocyclic and polycyclic group having 5 to 50 carbon atoms and
R is selected from the group consisting of substituted or unsubstituted divalent organic radicals, and more particularly consisting of (a) aromatic hydrocarbon radicals having 6 to 20 carbon atoms and halogenated derivatives thereof; (b) straight or branched chain alkylene radicals having 2 to 20 carbon atoms; (c) cycloalkylene radicals having 3 to 20 carbon atoms, and (d) divalent radicals of the general formula (Q):

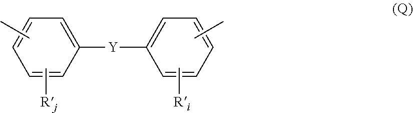

wherein Y is selected from the group consisting of alkylenes of 1 to 6 carbon atoms, in particular —C(CH₃)₂ and —C—H₂ₙ— (n being an integer from 1 to 6); perfluoroalkylenes of 1 to 6 carbon atoms, in particular —C(CF₃)₂ and —C—F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, and R′ is selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and i and j equal or different from each other, are independently 0, 1, 2, 3 or 4.
with the provisio that at least one of Ar, Ar′″ and R comprise at least one ether group wherein said ether group is present in the polymer chain backbone.

Preferably, Ar is selected from the group consisting of those complying with the following formulae:

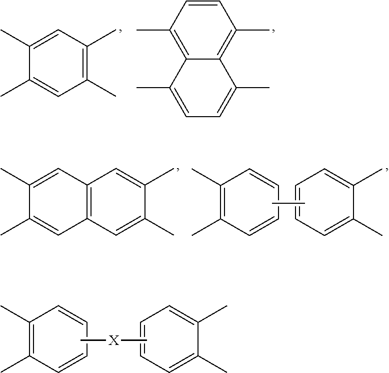

wherein X is a divalent moiety, having divalent bonds in the 3,3′, 3,4′, 4,3″ or the 4,4′ positions and is selected from the group consisting of alkylenes of 1 to 6 carbon atoms, in particular —C(CH₃)₂ and —C—H₂ₙ— (n being an integer from 1 to 6); perfluoroalkylenes of 1 to 6 carbon atoms, in particular —C(CF₃)₂ and —Cₙ—F₂ₙ— (n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂—; —SO—, or X is a group of the formula O—Ar″—O; and wherein Ar″ is selected from the group consisting of those complying with following formulae (S) to (Y), and mixtures thereof:

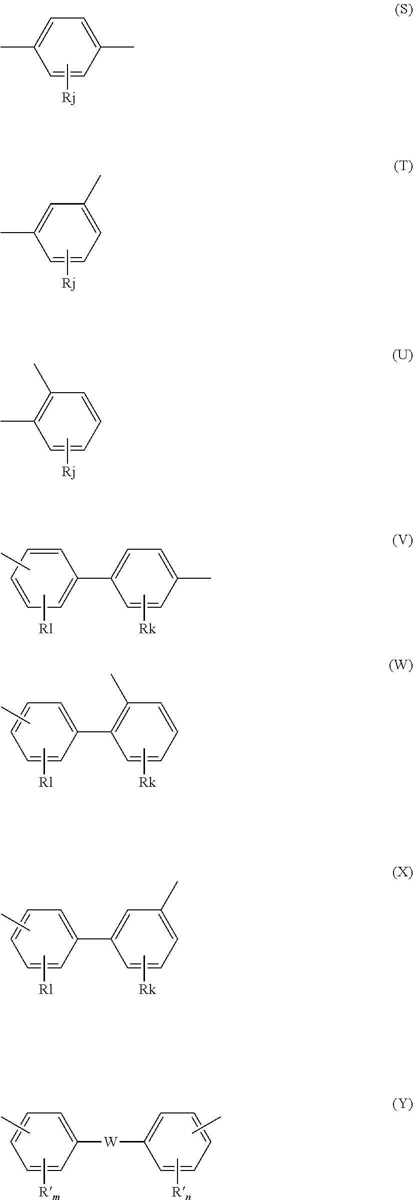

wherein R and R′, equal or different from each other, are independently selected from the group consisting of: hydrogen, halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium and j, k, l, n and m equal or different from each other, are independently 0, 1, 2, 3 or 4, and W is selected from the group consisting of alkylenes of 1 to 6 carbon atoms, in particular —C(CH₃)₂ and —C—H₂ₙ— (with n being an integer from 1 to 6); perfluoroalkylenes of 1 to 6 carbon atoms, in particular —C(CF₃)₂ and —CₙF₂ₙ— (with n being an integer from 1 to 6); cycloalkylenes of 4 to 8 carbon atoms; alkylidenes of 1 to 6 carbon atoms; cycloalkylidenes of 4 to 8 carbon atoms; —O—; —S—; —C(O)—; —SO₂— and —SO—.

Preferably, Ar′″ is selected from the group consisting of those complying with the following formulae:

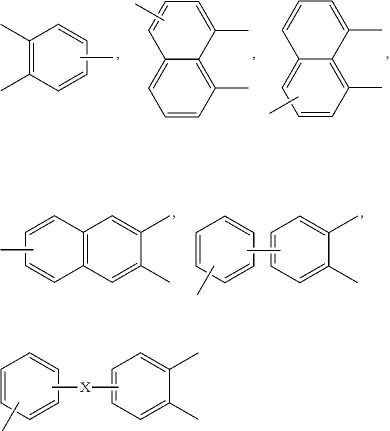

wherein X has the same meaning as defined above.

In a preferred embodiment, the recurring units (R_{PEIa}) are recurring units selected from the group consisting of those of formula (Z) in imide form, their corresponding amic acid forms of formulae (Z*) and (Z**), and mixtures thereof

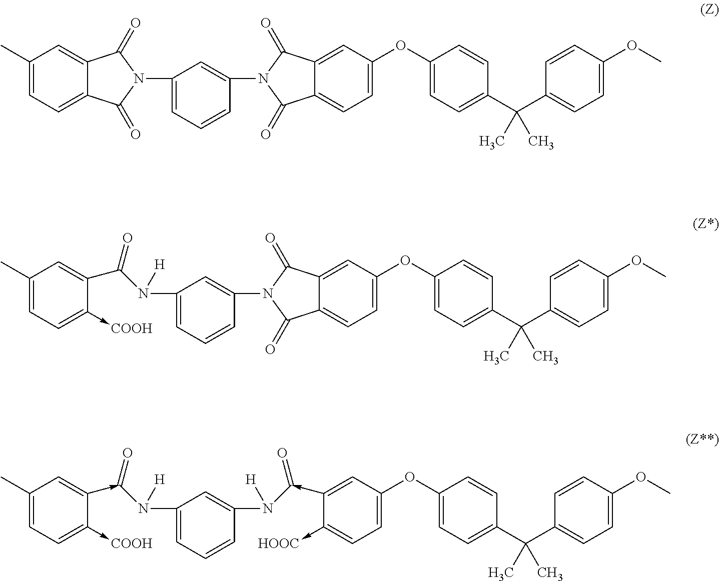

wherein in formulae (Z*) and (Z**) the → denotes isomerism so that in any recurring unit the groups to which the arrows point may exist as shown or in an interchanged position.

In another most preferred embodiment, the recurring units (R1a-4) are recurring units selected from the group consisting of those of formula (Z′) in imide form, their corresponding amic acid forms of formulae (Z′*) and (Z′**), and mixtures thereof:

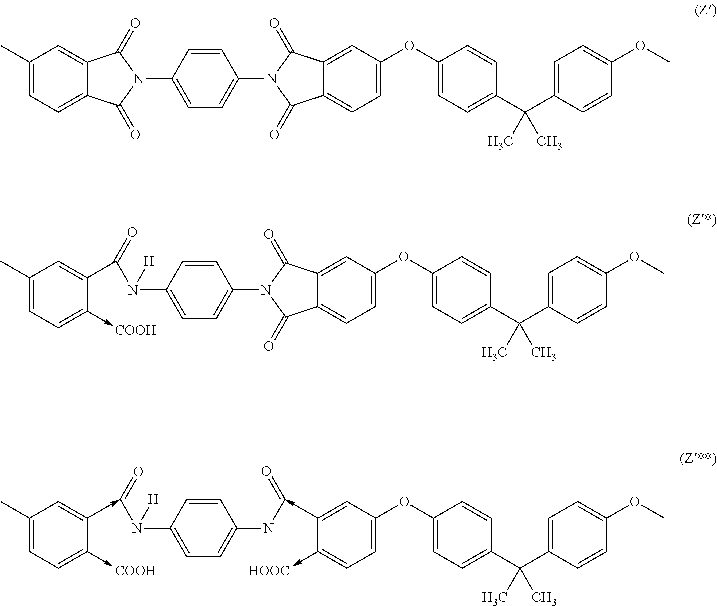

wherein in formulae (Z′*) and (Z′**) the → denotes isomerism so that in any recurring unit the groups to which the arrows point may exist as shown or in an interchanged position.

Preferably more than 75% by moles and more preferably more than 90% by moles of the recurring units of the PEI of the polymer composition (C) are recurring units (R_{PEIa}). Still more preferably, essentially all, if not all, the recurring units of the PEI are recurring units (R_{PEIa}).

In a preferred embodiment of the present invention, more than 75% by moles more preferably more than 90% by moles, more preferably more than 99% by moles, even more preferably all the recurring units of the PEI of the polymer composition (C) are recurring units selected from the group consisting of those in imide form of formula (Z), their corresponding amic acid forms of formulae (Z*) and (Z**), and mixtures thereof.

In another preferred embodiment of the present invention, more than 75% by moles, more preferably more than 90% by moles, more preferably more than 99% by moles, even more preferably all the recurring units of the PEI of the polymer composition (C) are recurring units selected from the group consisting of those in imide form of formula (Z′), their corresponding amic acid forms of formulae (Z′*) and (Z′**), and mixtures thereof.

Such aromatic polyimides are notably commercially available from Sabic Innovative Plastics as ULTEM® polyetherimides.

In a second embodiment of the present invention, the polymer composition (C) comprises at least one semi-crystalline polymer having a Tm of at least 250° C.

Preferably, the Tm is of at least 260° C., more preferably of at least 270° C., still more preferably of at least 280° C. In certain embodiment of the present invention, it is preferably of at least 300° C. and most preferably of at least 320° C.

In certain embodiments, said semi-crystalline polymer may also have a Tg of at least 80° C., preferably at least 100° C., more preferably at least 120° C.

In certain specific embodiments, a semi-crystalline polymer having a Tg of at most 100° C. and a Tm of at least 250° C. may preferably be used. In such a case, the polymer composition (C) preferably comprises a reinforcing filler such as glass fiber.

The semi-crystalline polymer having a Tm of at least 250° C. is preferably selected from the group consisting of poly(aryl ether ketones), liquid crystal polyesters and polyamides.

### The Poly(Aryl Ether Ketones)

For the purpose of the invention, the expressions “poly(aryl ether ketone)” and “(PAEK) polymer” are intended to denote any polymer, comprising recurring units, more than 50% moles of said recurring units are recurring units (R_{PAEK}) comprising a Ar—C(O)—Ar′ group, with Ar and Ar′, equal to or different from each other, being aromatic groups. The recurring units (R_{PAEK}) are generally selected from the group consisting of formulae (J-A) to (J-O), herein below:

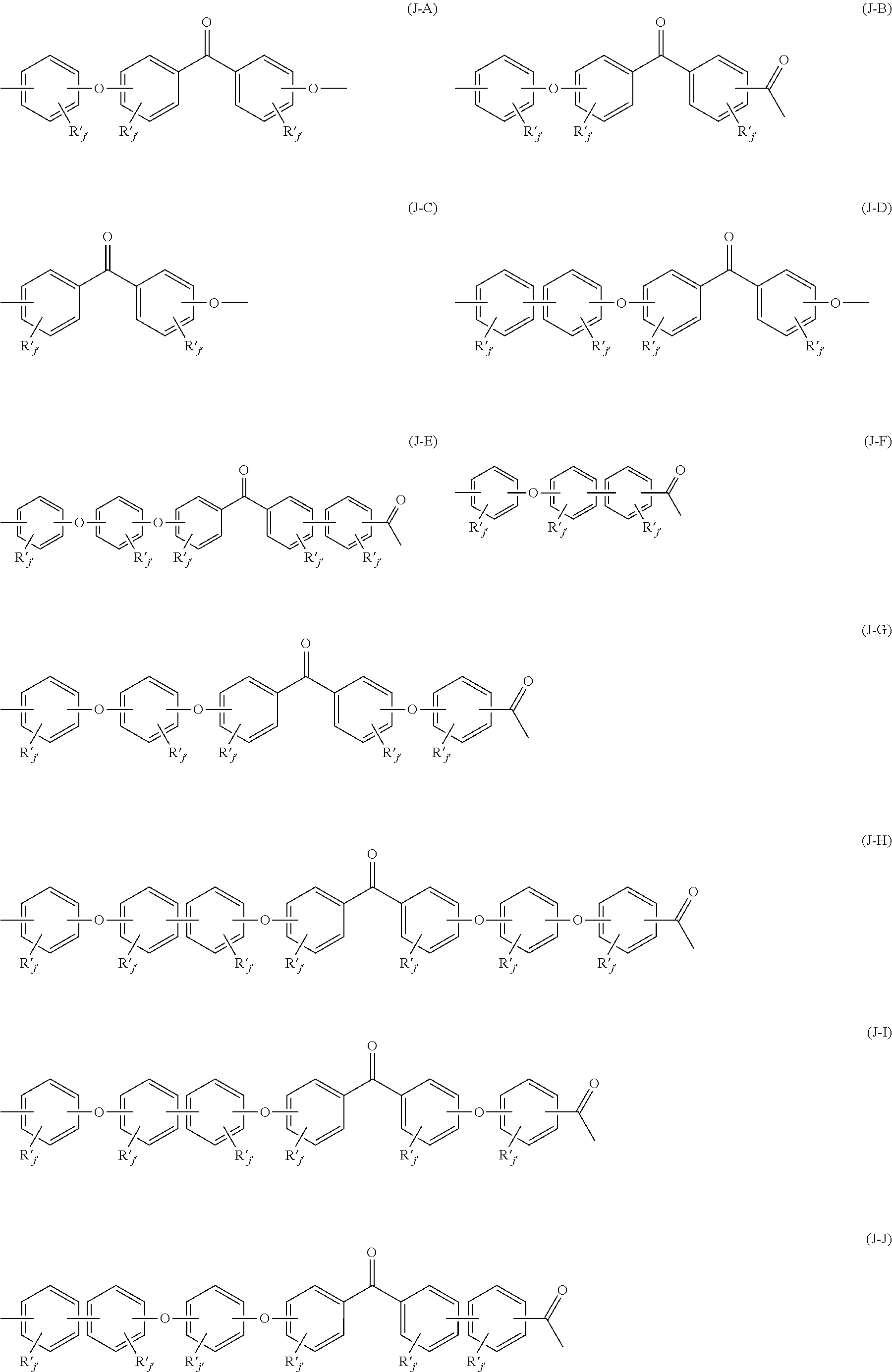

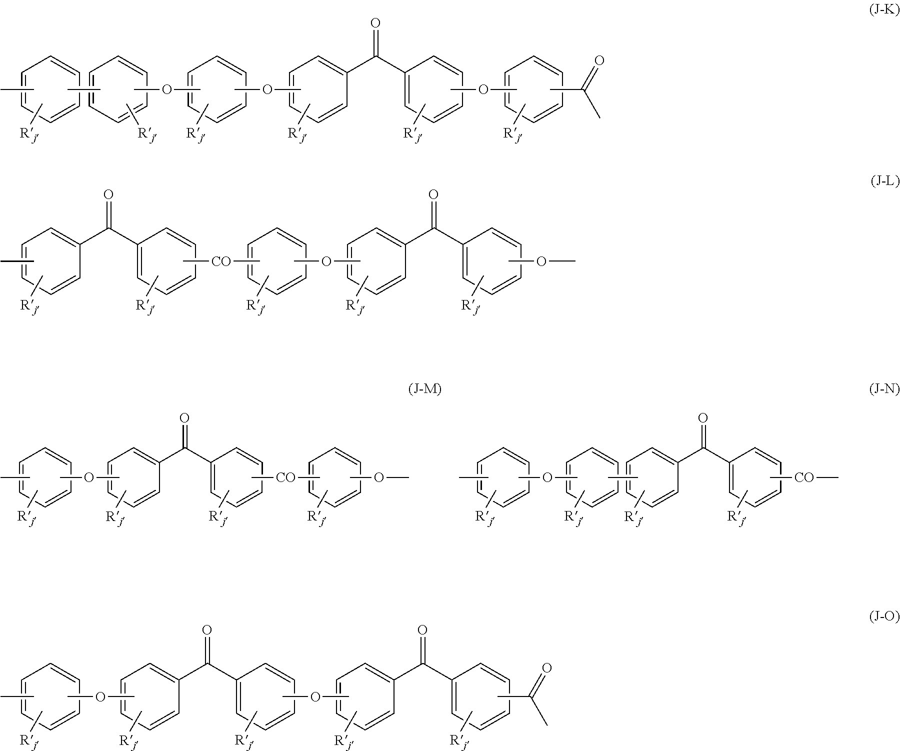

wherein:
each of R′, equal to or different from each other, is selected from the group consisting of halogen, alkyl, alkenyl, alkynyl, aryl, ether, thioether, carboxylic acid, ester, amide, imide, alkali or alkaline earth metal sulfonate, alkyl sulfonate, alkali or alkaline earth metal phosphonate, alkyl phosphonate, amine and quaternary ammonium;
j′ is zero or is an integer from 0 to 4.

In recurring unit (R_{PAEK}), the respective phenylene moieties may independently have 1,2-, 1,4- or 1,3-linkages to the other moieties different from R′ in the recurring unit. Preferably, said phenylene moieties have 1,3- or 1,4-linkages, more preferably they have 1,4-linkage.

Still, in recurring units (R_{PAEK}), j′ is preferably at each occurrence zero, that is to say that the phenylene moieties have no other substituents than those enabling linkage in the main chain of the polymer.

Preferred recurring units (R_{PAEK}) are thus selected from those of formulae (J′-A) to (J′-O) herein below:

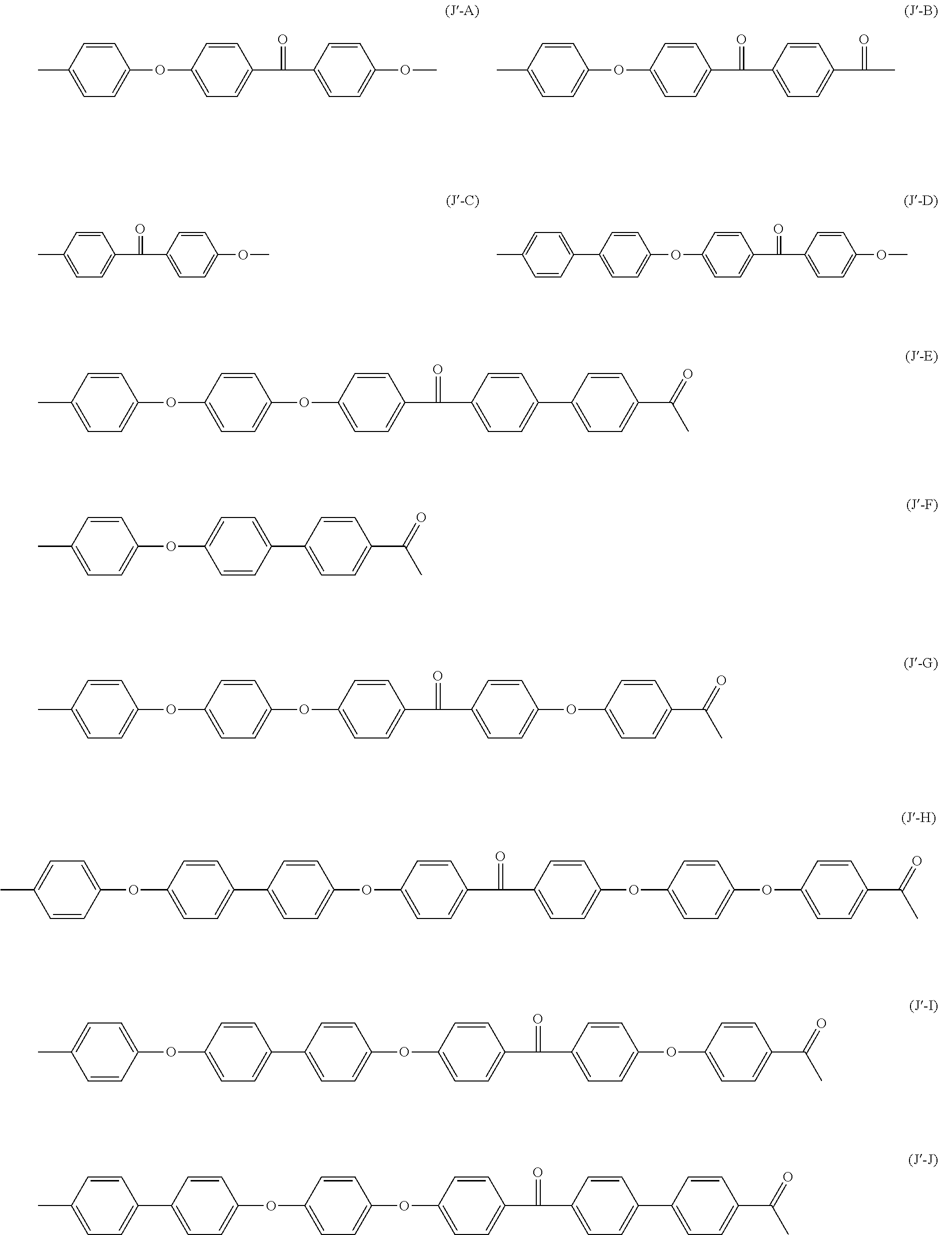

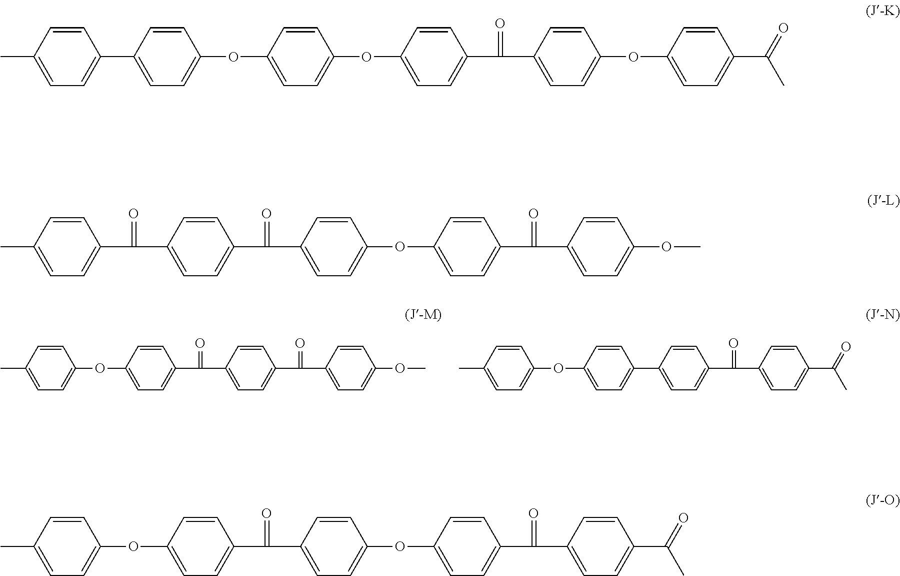

Still more preferably, (R_{PAEK}) are chosen from:

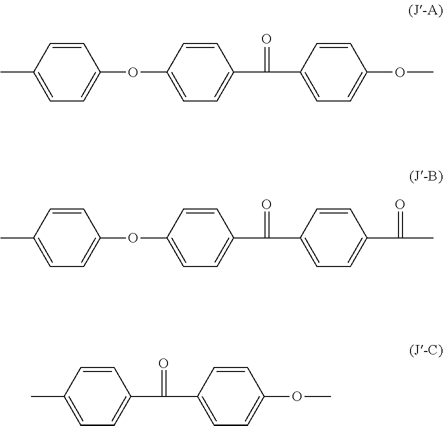

In the (PAEK) polymer, as detailed above, preferably more than 60 wt. %, more preferably more than 80 wt. %, still more preferably more than 90 wt. % of the recurring units are recurring units (R_{PAEK}), as above detailed.

The (PAEK) polymer of the polymer composition (C) may be notably a homopolymer, a random, alternate or block copolymer. When the (PAEK) polymer is a copolymer, it may notably contain (i) recurring units (R_{PAEK}) of at least two different formulae chosen from formulae (J-A) to (J-O), or (ii) recurring units (R_{PAEK}) of one or more formulae (J-A) to (J-O) and recurring units (R*_{PAEK}) different from recurring units (R_{PAEK}).

As will be detailed later on, the (PAEK) polymer of the polymer composition (C) may be a polyetheretherketone polymer [(PEEK) polymer, herein after]. Alternatively, the (PAEK) polymer may be a polyetherketoneketone polymer [(PEKK) polymer, herein after], polyetherketone polymer [(PEK) polymer, hereinafter] or a polyetheretherketone-polyetherketoneketone polymer [(PEEK-PEK) polymer, herein after].

For the purpose of the present invention, the term “(PEEK) polymer” is intended to denote any polymer of which more than 50 wt. % of the recurring units are recurring units (R_{PAEK}) of formula J′-A.

Preferably more than 75 wt. %, preferably more than 85 wt. %, preferably more than 95 wt. %, preferably more than 99 wt. % of the recurring units of the (PEEK) polymer are recurring units of formula J′-A. Most preferably all the recurring units of the (PEEK) polymer are recurring units of formula J′-A.

For the purpose of the present invention, the term “(PEKK) polymer” is intended to denote any polymer of which more than 50 wt. % of the recurring units are recurring units (R_{PAEK}) of formula J′-B.

Preferably more than 75 wt. %, preferably more than 85 wt. %, preferably more than 95 wt. %, preferably more than 99 wt. % of the recurring units of the (PEKK) polymer are recurring units of formula J′-B. Most preferably all the recurring units of the (PEKK) polymer are recurring units of formula J′-B.

For the purpose of the present invention, the term “(PEK) polymer” is intended to denote any polymer of which more than 50 wt. % of the recurring units are recurring units (R_{PAEK}) of formula J′-C.

Preferably more than 75 wt. %, preferably more than 85 wt. %, preferably more than 95 wt. %, preferably more than 99 wt. % of the recurring units of the (PEK) polymer are recurring units of formula J′-C. Most preferably all the recurring units of the (PEK) polymer are recurring units of formula J′-C.

The (PAEK) polymer of the polymer composition (C) can be prepared by any method known in the art for the manufacture of poly(aryl ether ketone)s.

Non limitative examples of commercially available (PAEK) polymers suitable for the invention include the KETASPIRE® polyetheretherketone commercially available from Solvay Specialty Polymers USA, LLC.

### The Liquid Crystal Polyesters

For the purpose of the invention, the expressions “liquid crystal polyester” and “LCP” are intended to denote any polymer, comprising recurring units, more than 80% moles of said recurring units are recurring units (R_{LCP}) which are obtained through the polycondensation of at least one aromatic dicarboxylic acid monomer and at least one aromatic diol monomer.

In a preferable embodiment the LCP contains recurring units (R_{LCP}) which are obtained through the polycondensation of at least one hydroxycarboxylic acid monomer, at least one aromatic dicarboxylic acid monomer compound and at least one aromatic diol monomer.

The LCP of the polymer composition (C) may contain recurring units (R_{LCP}) which are obtained through the polycondensation of one or more of the following aromatic dicarboxylic acid monomer units: terephthalic acid, isophthalic acid, 2,6-naphthalic dicarboxylic acid, 3,6-naphthalic dicarboxylic acid, 1,5-naphthalic dicarboxylic acid, 2,5-naphthalic dicarboxylic acid, 2,7-naphthalic dicarboxylic acid, 1,4-naphthalic dicarboxylic acid, 4,4′-dicarboxybiphenyl, and alkyl, aryl, alkoxy, aryloxy or halogen substituted derivatives thereof.

In addition to recurring units (R_{LCP}) which are obtained through the polycondensation of aromatic dicarboxylic acid monomer compounds, the LCP may also contain recurring units (R_{LCP}) which are obtained through the polycondensation of one or more of the following diol monomer units: 4,4′-biphenol, hydroquinone, resorcinol, 3,3′-biphenol, 2,4′-biphenol, 2,3′-biphenol, and 3,4′-biphenol, 2,6 dihydroxynaphthalene, 2,7-dihydroxynaphthalene, 1,6 dihydroxynaphthalene, 1,4-dihydroxynaphthalene, and alkyl, aryl, alkoxy, aryloxy or halogen substituted derivatives thereof.

Optionally, the LCP may contain recurring units (R_{LCP}) which are obtained through the polycondensation of one or more of the following aromatic hydroxycarboxylic acid monomer units: p-hydroxybenzoic acid, 5-hydroxyisophthalic acid, m-hydroxybenzoic acid, o-hydroxybenzoic acid, 4′ hydroxyphenyl-4-benzoic acid, 3′-hydroxyphenyl-4-benzoic acid, 4′ hydroxyphenyl-3-benzoic acid, 2,6-hydroxynaphthalic acid, 3,6-hydroxynaphthalic acid, 3,2-hydroxynaphthalic acid, 1,6-hydroxynaphthalic acid, and 2,5-hydroxynaphthalic acid, and alkyl, aryl, alkoxy, aryloxy or halogen substituted derivatives thereof.

In a preferable embodiment of the invention LCP comprises recurring units (R_{LCP}) which comprise at least one of the following structural units:
structural units (I) derived from hydroquinone,

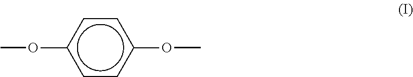

structural units (II) derived from 4,4′-biphenol,

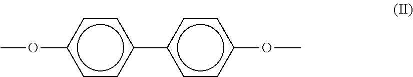

structural units (III) derived from terephthalic acid,

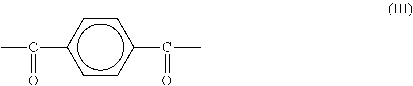

structural units (IV) derived from p-hydroxybenzoic acid,

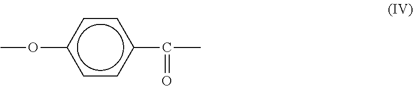

and, optionally in addition, structural units (V) derived from isophthalic acid;

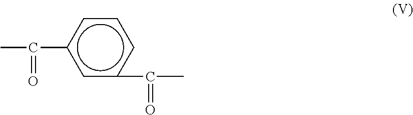

In other embodiments of the invention, the recurring units (R_{LCP}) contain only one of the structural units (I), (II), (III) and (IV), preferably at least two of the structural units (I)-(IV), more preferably at least three of the structural units (I)-(IV), even more preferably at least four of the structural units (I)-(IV). In still other embodiments of the invention the recurring units (R_{LCP}) contain only two of the structural units (I)-(IV), more preferably only three of the structural units (I)-(IV), even more preferably only four of the structural units (I)-(IV).

The recurring units (R_{LCP}) may also comprise polycondensed monomer units corresponding to structural units (I), (II), (III), (IV) and (V) in the following amounts: 5-40 mole % of a mixture of hydroquinone (I) and 4,4′-biphenol (II); 5-40 mole % of a mixture that comprises terephthalic acid (III) and isophthalic acid (V); and 40-90 mole % of p-hydroxybenzoic acid (IV). Mole % is based on the total number of moles of polycondensed monomer units corresponding to structural units (I)-(V) present in the LCP.

Preferably the recurring units (R_{LCP}) comprise polycondensed monomer units corresponding to structural units (I), (II), (III), (IV) and (V) in the following amounts: 10-30 mole % of a mixture of hydroquinone (I) and 4,4′-biphenol (II); 10-30 mole % of a mixture that comprises terephthalic acid (III) and isophthalic acid (V); and 40-80 mole % of p-hydroxybenzoic acid (IV). Mole % is based on the total number of moles of polycondensed monomer units corresponding to structural units (I)-(V) present in the LCP.

In another embodiment the recurring units (R_{LCP}) comprise polycondensed monomer units corresponding to structural units (I), (II), (III), (IV) and (V) in the following amounts: 13-28.5 mole %, preferably 15-25 mole %, more preferably 18-22 mole % of a mixture of hydroquinone (I) and 4,4′-biphenol (II); 13-28.5 mole %, preferably 15-25 mole %, more preferably 18-22 mole % of a mixture that comprises terephthalic acid (III) and isophthalic acid (V); and 43-74 mole %, preferably 45-70 mole %, more preferably 50-60 mole % of p-hydroxybenzoic acid (IV). Mole % is based on the total number of moles of polycondensed monomer units corresponding to structural units (I)-(V) present in the LCP.

In the LCP the mole ratio of the number of moles of recurring units (R_{LCP}) derived from isophthalic acid to the number of moles of monomer units derived from terephthalic acid may be from 0 to less than or equal 0.1.

In the LCP the ratio of the number of moles of monomer units derived from hydroquinone to the number of moles of monomer units derived from 4,4′-biphenol may be from 0.1 to 1.50. Preferably the molar ratio of the number of moles of monomer units derived from hydroquinone to the number of moles of monomer units derived from 4,4′-biphenol is from 0.2 to 1.25, 0.4 to 1.00, 0.6 to 0.8, or 0.5 to 0.7.

The molar ratio of structural units derived from monomers hydroquinone and 4,4′-biphenol to units derived from terephthalic and isophthalic acid is preferably from 0.95 to 1.05.

The mole ratio of oxybenzoyl units to the sum of terephthalic and isophthalic units may be within the range of from about 1.33:1 to about 8:1, i.e., compositions containing 60 to 85 mol % of p-hydroxybenzoic acid with respect to sum of p-hydroxybenzoic acid and total diols and further defined by isophthalic acid content of 0 to 0.09 mol % with respect to sum of the mols of isophthalic and terephthalic acid.

The terms “structural units”, “polycondensed monomer units”, and “monomer units derived from” refer to the chemical units present in the chemical structure of the LCP in their respective polycondensed forms. Formulas (I)-(V) above show the examples of the structures of these units. The term “monomer compound” refers to the pure aromatic diol, aromatic dicarboxylic acid or aromatic hydroxycarboxylic acid compound as it exists before undergoing an alcohol/acid polycondensation reaction.

The LCP optionally includes one or more other polycondensed monomer units derived from one or more compounds other than p-hydroxybenzoic acid, terephthalic acid, isophthalic acid, hydroquinone and 4,4′-biphenol.

In a preferable embodiment, the LCP include polycondensed monomer units that contain one or more naphthyl groups. For example, they may include one or more of 3-hydroxy-2-naphthoic acid, 6-hydroxy-2-naphthoic acid, 2-hydroxynaphthalene-3,6-dicarboxylic acid, 2,6-naphthalic dicarboxylic acid, 3,6-naphthalic dicarboxylic acid, 1,5-naphthalic dicarboxylic acid, 2,5-naphthalic dicarboxylic acid, 2,7-naphthalic dicarboxylic acid, 1,4-naphthalic dicarboxylic acid, 2,6-dihydroxynaphthalene, 2,7-dihydroxynaphthalene, 1,6-dihydroxynaphthalene, 1,4-dihydroxynaphthalene, and alkyl, aryl, alkoxy, aryloxy or halogen substituted derivatives thereof.

Preferably, the LCP contains only recurring units (R_{LCP}) made from p-hydroxybenzoic acid, terephthalic acid, isophthalic acid, hydroquinone and 4,4′-biphenol, or only monomer units derived from p-hydroxybenzoic acid, terephthalic acid, hydroquinone and 4,4′-biphenol. Within the context of the invention, LCP includes polycondensed recurring units (R_{LCP}) made from a mixture of p-hydroxybenzoic acid, terephthalic acid, isophthalic acid, hydroquinone and 4,4′-biphenol, that further includes other aromatic and non-aromatic monomer compounds present as unavoidable or adventitious impurities in the aromatic monomer compounds.

In preferred embodiments the LCP comprises polycondensed monomer units (i.e., polymerized structural units) in the following amounts: 50-70 mole % of p-hydroxybenzoic acid; 15 to 25 mole % of a mixture that comprises terephthalic acid and isophthalic acid; and 15-25 mole % of a mixture of hydroquinone and 4,4′-biphenol. All values and subranges between the stated values are expressly included herein as if written out, for example, p-hydroxybenzoic acid may be present in a range of 45-75, 55-65, and about 60 mole %, the mixture of terephthalic and isophthalic acid may be present in amounts of 12.5-27.5, 22.5-27.5, and about 20 mole %; and the mixture of hydroquinone and 4,4′-biphenol may be present in amounts of 12.5-27.5, 27.5-22.5, and about 20 mole %. All numbers between the stated values are expressly included herein as if written out, e.g., values between an exemplary range of 22.5 to 27.5 mole % include 23, 24, 25, 26, and 27 mole %. Mole % is based on the total number of moles of polymerized monomer units corresponding to structural units (I)-(V) present in the LCP.

In further preferred embodiments the LCP includes polycondensed structural units in the following amounts: 55-65 mole % of p-hydroxybenzoic acid; 16 to 23 mole % of terephthalic acid; 0 to 2 mole % of isophthalic acid; 1.5 to 14 mole % of hydroquinone; and 7 to 21 mole % of 4,4′-biphenol. More preferable still are embodiments in which the polymerized structural units are present in the following amounts: 58-62 mole % of p-hydroxybenzoic acid; 18 to 21 mole % of terephthalic acid; 0.1 to 1.0 mole % of isophthalic acid; 3.2 to 12.6 mole % of hydroquinone; and 7.5 to 17.5 mole % of 4,4′-biphenol. Preferably the amount of isophthalic acid is 2 mole % or less.

In a preferred embodiment the LCP includes at least 95 mole %, preferably 96, 97, 98 or 99 mole % of structural units derived from p-hydroxybenzoic acid, terephthalic acid, isophthalic acid, hydroquinone and 4,4′-biphenol. In an especially preferred embodiment the wholly LCP includes only structural units derived from p-hydroxybenzoic acid, terephthalic acid, isophthalic acid, hydroquinone and 4,4′-biphenol.

In other embodiments the LCP includes at least 50 mole %, preferably 60, 70, 80, or 90 mole % of structural units derived from p-hydroxybenzoic acid, terephthalic acid, isophthalic acid, hydroquinone and 4,4′-biphenol, with the balance of structural units representing other aromatic monomer compounds.

The Tm of the LCP of the invention are preferably less than 400° C. and greater than 300° C., more preferably less than 390° C. and greater than 325° C., especially preferably about 375° C.

LCP's can be produced in the melt by three main processes: the direct esterification of optionally substituted diphenols with aromatic carboxylic acids in the presence of catalysts such as titanium tetrabutyrate or dibutyl tin diacetate at high temperature; the reaction between phenyl esters of aromatic carboxylic acids with relevant optionally substituted diphenols, and lastly the acidolysis of diphenolic acetates with aromatic carboxylic acids.

As example of commercially available LCP, one can notably mention XYDAR® LCP from Solvay Specialty Polymers USA, LLC.

### The Polyamides

The expression “polyamide” is intended to denote any polymer which comprises recurring units (R_{PA}) which are derived from the polycondensation of at least one dicarboxylic acid component (or derivative thereof) and at least one diamine component, and/or from the polycondensation of amino carboxylic acids and/or lactams.

The expression ‘derivative thereof’ when used in combination with the expression ‘carboxylic acid’ is intended to denote whichever derivative which is susceptible of reacting in polycondensation conditions to yield an amide bond. Examples of amide-forming derivatives include a mono- or di-alkyl ester, such as a mono- or di-methyl, ethyl or propyl ester, of such carboxylic acid; a mono- or di-aryl ester thereof; a mono- or di-acid halide thereof; and a mono- or di-acid amide thereof, a mono- or di-carboxylate salt.

In certain preferred embodiment, the polyamide of the polymer composition (C) comprises at least 50 mol %, preferably at least 60 mol %, more preferably at least 70 mol %, still more preferably at least 80 mol % and most preferably at least 90 mol % of recurring units (R_{PA}). Excellent results were obtained when the polyamide of the polymer composition (C) consisted of recurring units (R_{PA}).

The polyamide of the polymer composition (C) may either be an amorphous polymer having a Tg of at least 150° C. or a semi-crystalline polymers having a Tm of at least 250° C.

The nature and quantities of the dicarboxylic acid component, the diamine component, and/or the aminocarboxylic acids and/or lactams has a great impact on the amorphous or semi-crystalline behaviour of the overall polyamide.

The polyamide of the polymer composition (C) is preferably an aromatic polyamide polymer. For the purpose of the present invention, the expression “aromatic polyamide polymer” is intended to denote a polyamide which comprises more than 35 mol %, preferably more than 45 mol %, more preferably more than 55 mol %, still more preferably more than 65 mol % and most preferably more than 75 mol % of recurring units (R_{PA}) which are aromatic recurring units. For the purpose of the present invention, the expression “aromatic recurring unit” is intended to denote any recurring unit that comprises at least one aromatic group. The aromatic recurring units may be formed by the polycondensation of at least one aromatic dicarboxylic acid with an aliphatic diamine or by the polycondensation of at least one aliphatic dicarboxylic acid with an aromatic diamine, or by the polycondensation of aromatic aminocarboxylic acids. For the purpose of the present invention, a dicarboxylic acid or a diamine is considered as “aromatic” when it comprises one or more than one aromatic group.

Non limitative examples of aromatic dicarboxylic acids are notably phthalic acids, including isophthalic acid (IA), terephthalic acid (TA) and orthophthalic acid (OA), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, the 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid, 1,2-naphthalene dicarboxylic acid.

Among aliphatic dicarboxylic acids, mention can be notably made of oxalic acid [HOOC—COOH, malonic acid (HOOC—CH₂—COOH), adipic acid [HOOC—(CH₂)₄—COOH], succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], 2,4,4-trimethyl-adipic acid [HOOC—CH(CH₃)—CH₂—C(CH₃)₂—CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecanedioic acid [HOOC—(CH₂)₁₀—COOH], tetradecanedioic acid [HOOC—(CH₂)₁₁—COOH], cis- and/or trans-cyclohexane-1,4-dicarboxylic acid and/or cis- and/or trans-cyclohexane-1,3-dicarboxylic acid (CHDA).

According to preferred embodiments of the present invention, the dicarboxylic acid is preferably aromatic. The polyamide is preferably a polyphthalamide, i.e. a polyamide comprising more than 50 mol % of recurring units formed by the polycondensation of at least one phthalic acid selected from the group consisting of isophthalic acid (IA), and terephthalic acid (TA). Isophthalic acid and terephthalic acid can be used alone or in combination. The phthalic acid is preferably terephthalic acid, optionally in combination with isophthalic acid.

Non limitative examples of aliphatic diamines are typically aliphatic alkylene diamines having 2 to 18 carbon atoms, which are advantageously selected from the group consisting of 1,2-diaminoethane, 1,2-diaminopropane, propylene-1,3-diamine, 1,3-diaminobutane, 1,4-diaminobutane, 1,5-diaminopentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1.8-diamino-1,3-dimethyloctane, 1,8-diamino-1,4-dimethyloctane, 1.8-diamino-2,4-dimethyloctane, 1,8-diamino-3,4-dimethyloctane, 1.8-diamino-4,5-dimethyloctane, 1.8-diamino-2,2-dimethyloctane, 1.8-diamino-3,3-dimethyloctane, 1,8-diamino-4,4-dimethyloctane, 1,6-diamino-2,4-diethylhexane, 1,9-diamino-5-methylnonane, 1,11-diaminoundecane and 1,12-diaminododecane.

Also, the aliphatic diamine may be chosen from cycloaliphatic diamines such as isophorone diamine (also known as 5-amino-(1-aminomethyl)-1,3,3-trimethylcyclohexane), 1,3-cyclohexanebis(methylamine) (1,3-BAMC), 1,4-cyclohexanebis(methylamine) (1,4-BAMC), 4,4-diaminodicyclohexylmethane (PACM), and bis(4-amino-3-methylcyclohexyl)methane.

According to preferred embodiments of the present invention, the aliphatic diamine is preferably selected from the group consisting of 1,6-diaminohexane (also known as hexamethylene diamine), 1,9-diaminononane, 1,10-diaminodecane, 1,11-diaminoundecane and 1,12-diaminododecane.

Among aromatic diamines, mention can be notably made of meta-phenylene diamine (MPD), para-phenylene diamine (PPD), 3,4′-diaminodiphenyl ether (3,4′-ODA), 4,4′-diaminodiphenyl ether (4,4′-ODA), meta-xylylene diamine (MXDA), and para-xylylene diamine (PXDA).

According to preferred embodiments of the present invention, the aromatic diamine is preferably MXDA, MPD or PPD.

In addition, aromatic amino carboxylic acids or derivatives thereof may also be used for the manufacture of the polyamide of the polymer composition (C), which is generally selected from the group consisting of 4-(aminomethyl)benzoic acid and 4-aminobenzoic acid, 6-aminohexanoic acid, 1-aza-2-cyclononanone, 1-aza-2-cyclododecanone, 11-aminoundecanoic acid, 12-aminododecanoic acid, 4-(aminomethyl)benzoic acid, cis-4-(aminomethyl)cyclohexanecarboxylic acid, trans-4-(aminomethyl)cyclohexanecarboxylic acid, cis-4-aminocyclohexanecarboxylic acid and trans-4-aminocyclohexanecarboxylic acid.

Non limitative examples of polyamides of the polymer composition (C) are the polymers of phthalic acid, chosen among isophthalic acid (IA) and terephthalic acid (TA) and at least one aliphatic diamine such as 1,6-diaminohexane (notably commercially available as AMODEL® polyphthalamides from Solvay Specialty Polymers U.S.A, L.L.C.), the polymer of terephthalic acid with 1,9-nonamethylene diamine, the polymer of terephthalic acid with 1,10-decamethylene diamine, the polymer of terephthalic acid with dodecamethylene diamine, the polymer of 1,11-undecane diamine with terephthalic acid, the copolymer of terephthalic acid and isophthalic acid with hexamethylene diamine, the copolymer of terephthalic acid with hexamethylene diamine and decamethylene diamine; the copolymer of terephthalic acid and isophthalic acid with hexamethylene diamine and decamethylene diamine; the copolymer of terephthalic acid with decamethylene diamine and 11-amino-undecanoic acid, the copolymer of terephthalic acid with hexamethylene diamine and 11-amino-undecanoic acid; the copolymer of terephthalic acid with hexamethylene diamine and bis-1,4-aminomethylcyclohexane; the copolymer of terephthalic acid with hexamethylene diamine and bis-1,3-aminomethylcyclohexane; the copolymer of hexamethylene diamine with terephthalic acid and 2,6-napthalenedicarboxylic acid; the copolymer of hexamethylene diamine with terephthalic acid and sebacic acid; the copolymer of hexamethylene diamine with terephthalic acid and 1,12-diaminododecanoic acid; the copolymer of hexamethylene diamine with terephthalic acid, isophthalic acid and 1,4-cyclohexanedicarboxylic acid; the copolymer of decamethylene diamine with terephthalic acid and 4-aminocyclohexanecarboxylic acid; the copolymer of decamethylene diamine with terephthalic acid and 4-(aminomethyl)-cyclohexanecarboxylic acid; the polymer of decamethylene diamine with 2,6-napthalenedicarboxylic acid; the copolymer of 2,6-napthalenedicarboxylic acid with hexamethylene diamine and decamethylene diamine; the copolymer of 2,6-napthalenedicarboxylic acid with hexamethylene diamine and decamethylene diamine; the polymer of decamethylene diamine with 1,4-cyclohexanedicarboxylic acid, the copolymer of hexamethylene diamine with 11-amino-undecanoic acid and 2,6-napthalenedicarboxylic acid; the copolymer of terephthalic acid with hexamethylene diamine and 2-methylpentamethylene diamine; the copolymer of terephthalic acid with decamethylene diamine and 2-methylpentamethylene diamine; the copolymer of 2,6-napthalenedicarboxylic with hexamethylene diamine and 2-methylpentamethylene diamine; the copolymer of 1,4-cyclohexanedicarboxylic acid with decamethylene diamine and 2-methylpentamethylene diamine.

According to a preferred embodiment of the invention, the polyamide of the polymer composition (C) is selected from the group consisting of the polymer of adipic acid with meta-xylylene diamine, the polymer of terephthalic acid with 1,9-nonamethylene diamine, the polymer of terephthalic acid with 1,10-decamethylene diamine, the copolymer of terephthalic acid and optionally isophthalic acid with hexamethylene diamine, the copolymer of terephthalic acid with hexamethylene diamine and decamethylene diamine and the copolymer of terephthalic acid and isophthalic acid with hexamethylene diamine and decamethylene diamine.

Among the above mentioned polymers of the polymer composition (C) selected from the group consisting of amorphous polymers having a Tg of at least 150° C. and semi-crystalline polymers having a Tm of at least 250° C., poly(aryl ether sulfones) and polyamides, as above detailed, are preferred. Poly(aryl ether sulfones) and PPSU, as above defined, in particular are mostly preferred.

In addition to the above mentioned polymers, the polymer composition (C) may comprise other ingredients, such as at least one reinforcing filler.

Reinforcing fillers may be particulate or fibrous. Particulate fillers may notably be chosen from talc, mica, kaolin, calcium carbonate, calcium silicate and magnesium carbonate. Reinforcing fillers are preferably fibrous. More preferably, the reinforcing filler is selected from glass fiber, carbon fiber, synthetic polymeric fiber, aramid fiber, aluminum fiber, titanium fiber, magnesium fiber, boron carbide fibers, rock wool fiber, steel fiber, etc. Still more preferably, it is selected from glass fiber, carbon fiber and wollastonite.

A particular class of fibrous fillers consists of whiskers, i.e. single crystal fibers made from various raw materials such as Al₂O₃, SiC, BC, Fe and Ni. Among fibrous fillers, glass fibers are preferred; they include chopped strand A-, E-, C-, D-, S- T- and R-glass fibers, as described in chapter 5.2.3, p. 43-48 of Additives for Plastics Handbook, 2nd ed., John Murphy. They also include glass fiber with elliptical or round cross-section.

In a preferred embodiment of the present invention the reinforcing filler is glass fiber.

If present, the reinforcing filler is preferably present in an amount of at least 2 wt. %, more preferably at least 4 wt. %, still more preferably at least 5 wt. %, and most preferably at least 10 wt. %, based on the total weight of the polymer composition (C). When present, the reinforcing filler is also preferably present in an amount of at most 40 wt. %, more preferably at most 35 wt. %, still more preferably at most 30 wt. %, based on the total weight of the polymer composition (C).

It is also preferably present in the composition in an amount from about 5 to about 40 wt. %, more preferably from about 5 to about 35 wt. %, and still more preferably from about 10 to about 30 wt. %, based on the total weight of the polymer composition (C).

The polymer composition (C) may also comprise other optional ingredients such as mold release agents, lubricants, optical brighteners and other stabilizers, different from the ones described above. Notably, the polymer composition (C) may comprise common stabilizers such as phosphites and zinc oxide.

The hot liquid dispensing device according to present invention comprises at least one hollow vessel made from a polymer composition (C). The hollow vessel of the present invention is intended to act as a container, delimiting a certain interior effective volume, aimed at containing the liquid to be heated in the hot liquid dispensing device according to the present invention. The hollow vessel of the present invention may have any shape. It may have an interior effective volume of at least 0.51, preferably at least 11, still more preferably at least 1.51.

The hollow vessel of the liquid boiling tank of the present invention is preferably made by injection molding.

The hollow vessel of the hot liquid dispensing device of the present invention may be fully enclosed or not fully enclosed.

According to a first specific embodiment, the liquid boiling tank is fully enclosed. In such a case, the hot liquid dispensing device according to present invention comprises only one hollow vessel made from the polymer composition (C). In such a case, the polymer composition (C) comprises preferably poly(aryl ether sulfones) or polyetherimides. Even more preferably, the polymer composition (C) comprises poly(aryl ether sulfones) or polyetherimides and glass fibers.

According to a second specific embodiment, the liquid boiling tank is not fully enclosed and is obtained by assembling at least two different hollow vessels or a hollow vessel and a cap made from distinct polymer compositions (C).

The hollow vessels and the optional cap are not made from stainless steel.

The first hollow vessel is made from a first polymer composition (C1) and the second hollow vessel is made from a second polymer composition (C2).

Preferably, the first polymer composition (C1) comprises a poly(aryl ether sulfone) (preferably PPSU) and the second polymer composition (C2) comprises a polyamide (preferably a polyphthalamide).

Preferably, the first hollow part made from the first polymer composition (C1) comprising a poly(aryl ether sulfone) material is the only hollow vessel which is in direct contact with the heating device.

Once assembled together to form an enclosed liquid boiling tank, the two different hollow vessels or the hollow vessel and the cap are preferably sealed together to provide the liquid boiling tank a very good liquid-tightness. Means for sealing the at least two different hollow parts include glue, adhesives, O-ring, over injection molding of one hollow part on the other, screwing, welding, ultrasonic, laser, welding, etc.

The liquid boiling tank of the present invention is preferably free from any metallic hollow vessel, in particular stainless steel hollow vessel. A metallic hollow vessel is intended to denote a metallic vessel delimiting an interior effective volume which is intended to act as a container aimed at containing the liquid to be heated or cap for the container. It does not intend to cover any metallic hose, electric device, heating element, coils, inlets, outlets, valves, sensors or thermostats which are connected to the liquid boiling tank. If any of those elements delimit an interior effective volume, they may act as a transportation mean for the liquid in and out from the liquid boiling tank but they have an interior effective volume of less than 0.41.

The liquid boiling tank of the hot liquid dispensing device for dispensing hot water or brewed beverages comprises at least one hollow vessel and a heating device which are in direct contact with each other. The terms “in direct contact” are intended to denote that at least some part of the external surface of the heating device touches at least some of the internal or external surface of the hollow vessel. The heating device is preferably mounted directly onto the hollow vessel and not for example on a stainless steel vessel or cap which is then assembled to the hollow vessel.

The pressure of the liquid circulating in the hot liquid dispensing device may reach 5-20 bars. The hot liquid dispensing device of the present invention integrates also all other usual elements present in such devices such as valves, temperature control device, flowmeter, means for steam generation and/or steam delivery, pumps, LED screen, electronic components, pipes etc.

Should the disclosure of any patents, patent applications, and publications which are incorporated herein by reference conflict with the description of the present application to the extent that it may render a term unclear, the present description shall take precedence.

### Examples

The relevant properties for making liquid boiling tanks of the following different materials were compared in the table 1 below:

PEEK: KETASPIRE® KT-880 polyetheretherketone (PEEK) polymer commercially available from Solvay Specialty Polymers USA, LLC.
PPSU: RADEL® R 5800 polyphenylsulfone (PPSU) polymer commercially available from Solvay Specialty Polymers USA, L.L.C.
PPA: AMODEL® A-1007 polyphthalamide (PPA) polymer commercially available from Solvay Specialty Polymers USA, L.L.C.
PA10T: VESTAMID® HT plus M3000, a PA10T-based polyphthalamide, commercially available from Evonik Industries.
PEI: ULTEM™ PW1000 polyetherimide (PEI) polymer commercially available from SABIC.

### LCP: XYDAR® SRT 900 Liquid Crystal Polymer

PPS: Z-200-E5 PPS commercially available from DIC.
PC: MAKROLON® 3108 commercially available from Bayer Material Science
PA6: TECHNYL® c206 commercially available from RHODIA, a member of the SOLVAY Group.
PE: RTP 700 HDPE commercially available from RTP Company.
Stainless steel: JFE 430LNM steel for hot liquid tanks commercially available from the JFE Steel Corporation, Japan.

The relevant properties for making liquid boiling tanks of the following different glass filled materials were also compared in the table 2 below:

GF-PEEK: 30% glass filled KETASPIRE® KT-880 GF30 polyetheretherketone (PEEK) polymer commercially available from Solvay Specialty Polymers USA, LLC.
GF-PPSU: 30% glass filed RADEL RG 5030 polyphenylsulfone (PPSU), commercially available from Solvay Specialty Polymers USA, LLC.
GF-PPA: 45% glass filled AMODEL® 1145 polyphthalamide (PPA) polymer commercially available from Solvay Specialty Polymers USA, L.L.C.
GF-10T: 30% glass filled VESTAMID® HT plus M3033, a PA10T-based polyphthalamide, commercially available from Evonik Industries.
GF-PEI: 30% glass filled ULTEM™ 2300F polyetherimide (PEI) polymer commercially available from SABIC.
GF-LCP: 30% glass filled XYDAR® G-930 Liquid Crystal Polymer (LCP), commercially available from Solvay Specialty Polymers USA, LLC.
GF-PPS: 40% glass filled FORTRON® 1140 L4 polyphenylene sulphide (PPS), commercially available from Ticona.
GF-PE: 30% glass filled RTP 705 HDPE commercially available from RTP Company.
GF-PA6: 30% glass filled TECHNYL® c 216 V30 commercially available from RHODIA, a member of the SOLVAY Group.

Melting temperatures and glass transition temperatures of the different resins and compounds were measured according to ASTM D 3418 using a TA Instruments Model Q20 Differential Scanning calorimeter and Liquid Nitrogen Cooling System operated with TA Thermal Advantage and Universal Analysis software. The instrument was calibrated using a heating and cooling rate of 20° C./min in nitrogen atmosphere. The measurements were also carried out using a heating and cooling rate of 20° C./min in nitrogen atmosphere. Melting temperatures and glass transition temperatures were determined from the second heating scan peak value. The hydrolysis resistance property shown in table 1 represents the resistance of the materials to exposure to 100° C. water in terms of integrity and mechanical properties retention over time. The chemical resistance property shown in table 1 represents the global resistance of the materials to acids.

The hydrolysis resistance, the taste, the chemical resistance, flame resistance, corrosion resistance and lime scale build up resistance have been rated with + and − signs according to the following scale:

−: poor
+: fair
++: good
+++: excellent

As one may read from the examples in tables 1 and 2, polymers E1 to E8 disclose advantageous properties which make them excellent candidates for the manufacture of liquid boiling tanks of the present invention. In particular, those resins are highly durable, do not corrode over time, are not thermally conductive do not provide any taste to the liquid, are flame resistant and are easy to process by injection molding, and allow the manufacture of liquid tanks with intricate designs and shapes.

To the contrary, comparative examples CE9 and CE10 (i.e. PA6 and HDPE, semi-crystalline polymers having a melting point temperature of less than 250° C.) fail to provide the minimum requirements for hydrolysis, thermal and chemical resistance needed for the liquid boiling tank application.

The properties of the material currently used on a commercial scale, stainless steel, have also been compared in comparative example CE11. As it may be seen from table 1, stainless steel is about 6 times heavier than the polymers of E1 to E7. Its thermal conductivity is also very detrimental to the preservation of the high temperature of the liquid in the liquid boiling tank. It is also not processable by injection molding and requires the use of very high temperatures.

Table 2 provides a comparison of seven glass filled compositions (E12 to E18) comprising the polymers being either amorphous polymers having a glass transition temperature of at least 150° C. or semi-crystalline polymers having a melting point temperature of at least 250° C. (E1 to E7) which are excellent candidates for the manufacture of liquid boiling tanks of the present invention. In contrast, the same results are also presented for two glass filed compositions (CE19 and CE20) of semi-crystalline polymers having a melting point temperature of less than 250° C. to show that the presence of glass fiber is not sufficient to boost the properties of the compounds to a sufficient level for them to be used for the manufacture of liquid boiling tanks

TABLE 1
Comparison of properties of neat resins vs. stainless steel

| | | | | | | | | | | | | CE11 |
|---|---|---|---|---|---|---|---|---|---|---|---|---|
| | | | | | | | | | | | | Stain- |
| | | E1 | E2 | E3 | E4 | E5 | E6 | E7 | CE8 | CE9 | CE10 | less |
| | Test Method | PEEK | PPSU | PPA | PA 10T | LCP | PEI | PPS | PC | PE | PA6 | steel |
| Density | ASTM D792 | 1.30 | 1.29 | 1.23 | 1.1 | 1.40 | 1.27 | 1.32 | 1.20 | 0.95 | 1.14 | 7.72 |
| Tensile Strength | ASTM D638 | 100 | 70 | 82 | 65 | 130 | 105 | 70 | 65 | 20 | 85 | 410 |
| (MPa) | | | | | | | | | | | | |
| Tensile Modulus | ASTM D638 | 3700 | 2340 | / | / | / | / | 3100 | / | 1241 | 2850 | / |
| (MPa) | ISO 527 | 4000 | / | 3900 | 2700 | 11000 | 3200 | / | 2350 | / | / | |
| Tensile Elongation | ASTM D638 | 10-20 | 60-120 | 2.5 | 5 | 2 | 60 | 50 | 120 | >10 | 120 | 20 |
| at break (%) | | | | | | | | | | | | |
| Tg (° C.) | ASTM D3418 | 147 | 220 | 133 | 125 | / | 217 | 85 | 149 | / | 55 | / |
| Tm (° C.) | ASTM D3418 | 343 | N/A | 320 | 285 | 355 | N/A | 280 | N/A | 92 | 222 | >1400 |
| HDT (° C.) | 0.45 MPa, | / | / | 133 | 225 | 290 | 200 | / | 141 | / | 217 | / |
| | ASTM D648 | | | | | | | | | | | |
| | 1.8 MPa, | 160 | 207 | 176 | 122 | 250 | 190 | 105 | 129 | / | 200 | / |
| | ASTM D648 | | | | | | | | | | | |
| Thermal conductivity | ASTM E1530 | 0.25 | 0.30 | / | / | / | / | / | / | / | / | / |
| (W/m/K) | ASTM C177 | / | / | / | / | 0.19 | / | / | / | / | / | / |
| | ISO 8302 | / | / | / | / | / | 0.24 | / | 0.20 | / | / | / |
| | —* | / | / | / | / | / | / | / | / | / | / | 29.7 |
| Hydrolysis resistance | — | +++ | +++ | + | + | ++ | ++ | ++ | − | + | − | + |
| Taste | — | ++ | ++ | ++ | ++ | ++ | ++ | ++ | ++ | − | + | + |
| Chemical Resistance | — | +++ | ++ | + | + | ++ | ++ | ++ | − | + | − | + |
| Flame Resistance | — | ++ | +++ | + | + | +++ | +++ | +++ | + | − | + | +++ |
| Corrosion resistance | — | +++ | +++ | +++ | +++ | +++ | +++ | +++ | +++ | +++ | +++ | − |
| Lime scale build | — | +++ | +++ | + | + | +++ | +++ | +++ | + | +++ | + | − |
| up resistance | | | | | | | | | | | | |
| Injection Moldable | — | Y | Y | Y | Y | Y | Y | Y | Y | Y | Y | N |

*test method not disclosed by the manufacturer

TABLE 2
Comparison of properties of glass filed resins

| | | E12 | E13 | E14 | E15 | E16 | E17 | E18 | CE19 | CE20 |
|---|---|---|---|---|---|---|---|---|---|---|
| | Test Method | GF-PEEK | GF-PPSU | GF-PPA | GF-10T | GF-PEI | GF-LCP | GF-PPS | GF-PE | GF-PA6 |
| Density (g/cm³) | ASTM D792 | 1.53 | 1.55 | 1.61 | 1.36 | 1.51 | 1.60 | 1.72 | 1.16 | 1.35 |
| Tensile Strength | ASTM D638 | 174 | 118 | 232 | 170 | 165 | 135 | 200 | 52 | 190 |
| (MPa) | | | | | | | | | | |
| Tensile Modulus | ASTM D638 | 10800 | 8140 | / | / | / | 15900 | − | 5861 | / |
| (MPa) | ISO 527 | / | / | 15100 | 9400 | 9500 | / | | / | 9600 |
| Tensile Elongation | ASTM D638 | 2.8 | 2.2 | 1.8 | 2.4 | 2 | 1.6 | 2 | 2-4 | 3.8 |
| at break (%) | | | | | | | | | | |
| Tg (° C.) | ASTM D3418 | 147 | 220 | 133 | 125 | 217 | / | 85 | / | 55 |
| Tm (° C.) | ASTM D3418 | 343 | N/A | 320 | 285 | N/A | 355 | 280 | 92 | 222 |
| HDT (° C.), 0.45 MPa | ASTM D648 | / | / | / | 286 | 212 | / | 280 | / | / |
| HDT (° C.), 1.8 MPa | ASTM D648 | 315 | 214 | 302 | 266 | 210 | 271 | 266 | / | 205 |
| Hydrolysis resistance | — | +++ | +++ | + | + | ++ | ++ | ++ | + | − |
| Taste | — | ++ | ++ | ++ | ++ | ++ | ++ | ++ | − | + |
| Chemical Resistant | — | +++ | ++ | + | + | ++ | ++ | ++ | + | − |
| Flame Resistant | — | ++ | +++ | + | + | +++ | +++ | +++ | − | + |
| Corrosion resistant | — | +++ | +++ | +++ | +++ | +++ | +++ | +++ | +++ | +++ |
| Lime scale build | — | +++ | +++ | + | + | +++ | +++ | +++ | +++ | + |
| up resistance | | | | | | | | | | |
| Injection Moldable | — | Y | Y | Y | Y | Y | Y | Y | Y | Y |

1-15: (canceled)

16. A hot liquid dispensing device for dispensing hot water or brewed beverages comprising a liquid boiling tank, wherein the liquid boiling tank:
comprises at least one hollow vessel made of a polymer composition (C) comprising at least one polymer (P) selected from the group consisting of amorphous polymers having a glass transition temperature of at least 150° C. and semi-crystalline polymers having a melting point temperature of at least 250° C., and
a heating device,
wherein the heating device is in direct contact with said hollow vessel.

17. The hot liquid dispensing device according to claim 16, wherein the polymer composition (C) comprises at least one amorphous polymer having a glass transition temperature of at least 150° C.

18. The hot liquid dispensing device according to claim 16, wherein the amorphous polymer is a poly(aryl ether sulfone).

19. The hot liquid dispensing device according to claim 18, wherein the poly(aryl ether sulfone) is selected from the group consisting of PSU, PESU, and PPSU.

20. The hot liquid dispensing device according to claim 19, wherein the poly(aryl ether sulfone) is PPSU.

21. The hot liquid dispensing device according to claim 16, wherein the polymer composition (C) comprises at least one semi-crystalline polymer having a glass transition temperature of at least 100° C.

22. The hot liquid dispensing device according to claim 21, wherein the semi-crystalline polymer is selected from the group consisting of poly(aryl ether ketones) and polyamides.

23. The hot liquid dispensing device according to claim 21, wherein the semi-crystalline polymer is a polyamide.

24. The hot liquid dispensing device according to claim 22, wherein the semi-crystalline polymer is a poly(aryl ether ketone).

25. The hot liquid dispensing device according to claim 16, wherein the liquid boiling tank comprises only one hollow vessel made of the polymer composition (C).

26. The hot liquid dispensing device according to claim 16, wherein said hollow vessel is obtained by assembling a first hollow vessel made of a first polymer composition (C1) and a second hollow vessel made of a second polymer composition (C2).

27. The hot liquid dispensing device according to claim 26, wherein the first polymer composition (C1) comprises a poly(aryl ether sulfone) and the second polymer composition (C2) comprises a polyamide.

28. The hot liquid dispensing device according to claim 26, wherein the first hollow vessel made of the first polymer composition (C1) is the only hollow vessel which is in direct contact with the heating device.

29. The hot liquid dispensing device according to claim 16, wherein the heating device is a thermoblock or an on demand heater.

30. A method for preparing tea, coffee, soup, or other hot beverages where hot liquid is dispensed from the hot liquid dispensing device according to claim 16.

31. The hot liquid dispensing device according to claim 23, wherein the polyamide is a polyphthalamide.

32. The hot liquid dispensing device according to claim 24, wherein the poly(aryl ether ketone) is PEEK.
